(19) United States
(12) Patent Application Publication
(10) Pub. No.: US 2015/0060414 A1
(43) Pub. Date: Mar. 5, 2015

(54) Welding Device for Welding a Connecting Portion and Method for Welding the Connecting Portion with the Welding Assembly

(71) Applicant: GM GLOBAL TECHNOLOGY OPERATIONS LLC, Detroit, MI (US)

(72) Inventor: Walter Riether, NAUHEIM (DE)

(21) Appl. No.: 14/477,651

(22) Filed: Sep. 4, 2014

(30) Foreign Application Priority Data
Sep. 5, 2013 (DE) 102013014701.8

(51) Int. Cl. B23K 11/00; B23K 35/02; B23K 11/30; B23K 11/11; B23K 11/16

(52) U.S. Cl. CPC B23K 11/0033; B23K 11/115; B23K 11/163; B23K 11/3018; B23K 35/0277
USPC 219/86.31; 219/86.1; 219/91.2

(57) ABSTRACT

A welding device for welding a thicker sheet and a thinner sheet arranged congruently together. A first welding electrode having a first heat reflector or welding mirror contacts the thicker sheet with a first contact surface. A second welding electrode having a heat reflector or second welding mirror contacts the thinner sheet with a second contact surface. The first and second contact surfaces 8, 10 are at least partially congruent, and the first contact surface is larger than the second contact surface by at least a factor of two.

### CROSS REFERENCE TO RELATED APPLICATION

This application claims priority to German Patent Application No. 102013014701.8 filed Sep. 5, 2013 which is incorporated herein by reference in its entirety.

### TECHNICAL FIELD

The technical field relates to a welding device for welding a connecting section, wherein the connecting section includes a thicker sheet and a thinner sheet. The present disclosure also relates to a method for welding the connecting section with the welding device.

### BACKGROUND

Welding is sufficiently known as a method for joining together two sheets. In the welding process, opposing electrodes are placed on two sheets superimposed upon one another. Voltage is applied to the electrodes, so that current flows through the metal sheet, and a weld point is generated, which joins together the sheets. The electrodes often exhibit circular welding mirrors, so that the weld point also has a circular design. An annular welding mirror has also become known from prior art.

EP 0 173 656 B1 describes a conventional method for welding metal sheets superimposed upon one another by locally heating and melting the sheets. Electrodes essentially shaped like pipes are placed on the sheets. Applying voltage to generate an electrical current flow produces an annular weld point on the sheets.

### SUMMARY

In accordance with the present disclosure a welding device is provided that is functionally improved and flexible in use. A welding device for welding a connecting section is proposed. The connecting section is preferably designed as a so-called lap joint. The connecting section includes a thicker and thinner sheet, in particular a metal sheet. The thicker and thinner sheets are arranged congruently to each other in the connecting section.

The welding device includes a first and second welding electrode. The latter can optionally be cooled with water. The first welding electrode exhibits a first heat reflector or welding mirror, which may be designed as a conductive and/or heatable metal piece, in particular a metal plate. The first welding mirror is designed to contact the thicker sheet with a first contact surface in the connecting section. In particular, the first contact surface is the surface with which the first welding mirror contacts the thicker sheet.

The second welding electrode exhibits a second heat reflector or welding mirror. For example, the latter is designed as a conductive and/or heatable metal piece. The second welding mirror is designed to contact the thinner sheet with a second contact surface in the connecting section. In particular, the second contact surface is the surface with which the second welding mirror contacts the thinner sheet.

Especially in a cross section through the connecting section, the first and second contact surfaces are at least partially congruent. The first and second contact surfaces are preferably completely congruent. The first contact surface is larger than the second contact surface by at least a factor of 2. Within the framework of the present disclosure, it is provided that the first contact surface of the first welding mirror is larger than the contact surface of the second welding mirror by at least a factor of 2. In particular, the second contact surface of the second welding mirror is reduced by comparison to the first contact surface of the first welding mirror, e.g., by a modified and/or varied outer contour configuration. The second welding mirror is easy and cost-effective to change. In order to weld the connecting section, voltage is preferably applied to the welding electrodes, so that current flows between the contact surfaces and sheets, and a weld point is formed. In particular, the first and second contact surfaces are the surfaces by which the current is conveyed to the sheets while applying a voltage to the welding electrodes.

As generally known from conventional welding devices, the small sheet thickness of thin sheets makes it impossible to generate enough resistance to sufficiently heat, melt and thus reliably weld the thin sheet. The thinner sheet can alternatively be reliably heated and melted by increasing the current density of the current flowing through the second welding electrode. According to the present disclosure, the current density is advantageously increased by having the second contact surface of the second welding mirror be at most half as large as the first contact surface of the first welding mirror. In particular, the current density can be increased by up to 30 percent, especially by up to 25 percent and/or by at least 10 percent, without diminishing the strength of the thinner sheet.

In a preferred embodiment of the present disclosure, the first contact surface of the first welding mirror is circular and holohedral. The first circular and holohedral contact surface preferably exhibits a diameter of at least 3 millimeters, preferably of at least 5 millimeters, especially of at least 7 millimeters and/or of at most 10 millimeters. In an especially preferred, specific embodiment of the present disclosure, the first circular contact surface exhibits a diameter of 6 millimeters.

In a possible implementation of the present disclosure, the second contact surface is rotationally symmetrical. Within the framework of the present disclosure, it is possible that the second contact surface be formed by an entirely cohesive region. As an alternative, the second contact surface can also be formed by or include several regions separated from each other.

In an especially preferred implementation of the present disclosure, the second contact surface of the second welding mirror is annular, in particular toroidal. The second, annular contact surface preferably exhibits an overall diameter of at least 3 millimeters, particularly of at least 5 millimeters, especially of at least 7 millimeters and/or of at most 10 millimeters. As an option, the second, annular contact surface of the second annular welding mirror exhibits a ring width of at least 1 millimeter, particularly of at least 1.3 millimeters, especially of at least 1.6 millimeters and/or of at most 2 millimeters.

In an especially preferred implementation of the present disclosure, the second contact surface of the second welding mirror exhibits an overall diameter of 6 millimeters, and a ring width of 1.5 millimeters. The annular configuration of the second contact surface makes it possible to increase the current density of the current flowing through the second welding electrode. As a consequence, increasing the current density can bring about process reliability while welding without any loss in strength for the thinner sheet.

It is especially preferred that the diameter of the first contact surface of the first welding mirror correspond to the outer diameter of the second contact surface of the second welding mirror. As a result, the first and second contact surface can be completely congruent and reliably welded. This enables a continuous ultrasonic inspection of the equally sized and congruently arranged contact surfaces.

In a preferred implementation of the present disclosure, the thicker sheet and thinner sheet lie directly on top of each other in the connecting section. The thicker and thinner sheets are preferably welded directly to each other. Alternatively possible within the framework of the present disclosure is for at least one additional sheet to be arranged in the connecting section between the thicker and thinner sheet. It is here preferred that the thinner sheet be situated outside on one side of the connecting section. In particular, the thinner sheet forms an outer and/or visible side of the connecting section.

In a preferred embodiment of the present disclosure, the welding device includes the thicker and thinner sheet. The thicker sheet preferably exhibits a thickness of at least 0.7 millimeters and/or of at most 1.2 millimeters, particularly of at most 1 millimeter. It is especially preferred that the thinner sheet exhibit a maximum thickness of 0.6 millimeters, in particular 0.5 millimeters and/or of at least 0.2 millimeters. A ratio between the thickness of the thinner sheet D2 and the thickness of the thicker sheet D1 can optionally be greater than 1:3 (D2/D2>1/3).

For example, the thicker and/or the thinner sheets are designed as a steel sheet. In a preferred specific embodiment of the present disclosure, the thicker sheet is designed as a coated steel sheet for a vehicle structure. The thinner sheet is optionally designed as a coated outer skin for the vehicle structure.

The present disclosure also relates to a method for welding the connecting section with the thicker and thinner sheet. Within the framework of the method, the thicker and thinner sheets are congruently arranged, so that they form a connecting section. The first heat reflector or welding mirror of the first welding electrode is placed in the connecting section with the first contact surface on the thicker sheet. The second heat reflector or welding mirror of the second welding electrode is placed in the connecting section with the second contact surface on the thinner sheet. The first and second welding mirrors are here placed in such a way that the first and second contact surfaces, in particular in a cross section through the connecting section, are at least partially, and preferably completely congruent. Voltage is applied to the first and second welding electrodes. As a consequence, current flows over the contact surfaces of the welding mirrors and through the sheets, thereby welding the latter together.

Within the framework of the method, the second welding mirror of the second welding electrode is optionally milled out of another originally annular and holohedral first welding mirror by means of a milling cutter that is suitable and/or designed for this purpose. The advantage to this is that the first and/or second welding electrode, in particular the first and/or second welding mirror, can be cooled with water while welding the connecting section.

### BRIEF DESCRIPTION OF THE DRAWINGS

The present disclosure will hereinafter be described in conjunction with the following drawing figures, wherein like numerals denote like elements.

FIG. 1 shows a welding device with a thicker and thinner sheet and with a first and second welding electrode;

FIG. 2 shows a contact surface and/or a welding mirror of the first welding electrode;

FIG. 3 shows a contact surface and/or a welding mirror of the second welding electrode;

FIG. 4 shows a flowchart for a method of welding the thicker and thinner sheet with the welding device from FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description. Mutually corresponding or identical parts on the figures are each marked with the same reference number.

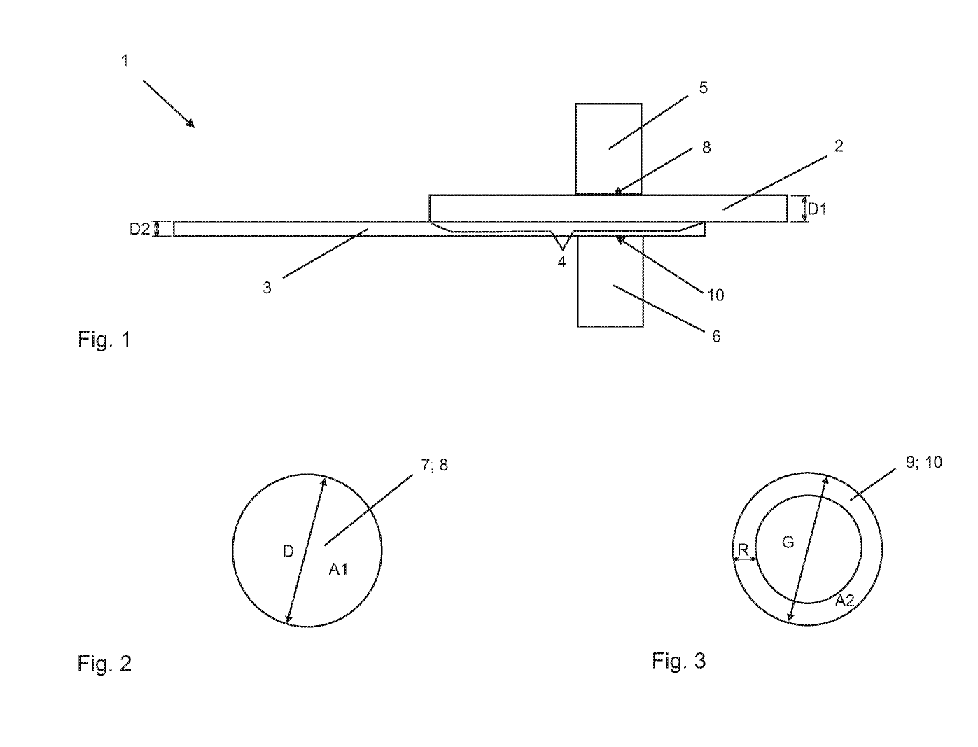

FIG. 1 shows a cross section through a welding device 1 as an exemplary embodiment of the present disclosure, wherein a cutting line runs perpendicular to a surface extension of the first and second sheets. The welding device 1 exhibits a connecting section 4, in particular a so-called lap joint, which is included of a thicker sheet 2 and a thinner sheet 3. The thicker sheet 2 lies congruently on the thinner sheet 3 in the connecting section. The thicker sheet 2 is designed as a coated steel sheet for a vehicle structure, while the thinner sheet 3 is designed as a coated outer skin for the vehicle structure. As an alternative, at least one additional sheet can be situated in the connecting section 4 between the thicker sheet 2 and thinner sheet 3.

The welding device 1 includes a first welding electrode 5 and a second welding electrode 6. The first welding electrode 5 is placed on the thicker sheet 2 in the connecting section 4, while the second welding electrode 6 is placed on the thinner sheet 3. Both welding electrodes 5 are situated directly opposite each other on the sheets 2, 3.

The first welding electrode 5 exhibits a first heat reflector or welding mirror 7. It contacts the thicker sheet 2 with the first welding mirror 7, and thereby forms a first contact surface 8 of the first welding mirror 7. The second welding electrode 6 exhibits a second heat reflector or welding mirror 9. It contacts the thinner sheet 3 with the second welding mirror 9, and thereby forms a second contact surface 10 of the second welding mirror. The electrodes 5, 6 are placed on the sheets 2, 3 in such a way that the contact surfaces 8, 10 are completely congruent relative to each other.

In order to weld together both sheets 2, 3, voltage is applied to the welding electrodes 5, 6, so that current flows between the contact surfaces 8, 10 and through the sheets 2, 3. Because the thicker sheet 2 exhibits a sufficient resistance, it can be heated, melted and reliably welded given a circular and holohedral configuration of the first contact surface 8. Due to the diminished thickness of the thinner sheet 3, not enough resistance is present to weld the thinner sheet 3 reliably with a circular, holohedral contact surface, contrary to the case of the thicker sheet 2. The thinner sheet 3 requires that the current density of the current flowing through the second contact surface 10 into the thinner sheet 3 be increased, so that it can be sufficiently heated, melted and thus reliably welded.

The thicker sheet preferably exhibits a thickness D1 of at least 0.7 millimeters and/or at most 1.2 millimeters, in particular of at most 1 millimeter. The thinner sheet 3 exhibits a thickness D2 of at least 0.4 millimeters and/or of at most 0.6 millimeters, in particular of at most 0.5 millimeters. As an alternative or added option, a ratio between the thickness D2 of the thinner sheet 3 and the thickness D1 of the thicker sheet 2 is greater than 1:3.

FIG. 2 shows a top view from above of the first contact surface 8 and/or the first welding mirror 7 of the first welding electrode 5 from FIG. 1. The first contact surface 10 of the first welding mirror 7 is circular and holohedral, and exhibits a diameter D of at least 3 millimeters, preferably of at least 5 millimeters, in particular of at least 7 millimeters and/or of at most 10 millimeters.

Due to the thickness of the thicker sheet 2 (FIG. 1), sufficient resistance is present to heat and melt, in particular reliably weld, the thicker sheet 2 while applying voltage to the first welding electrode 5, even given a circular, holohedral first contact surface 10.

FIG. 3 shows a top view of the second contact surface 10 of the second welding mirror 9 of the second welding electrode 6. The second contact surface 10 of the second welding mirror 9 is annular, in particular toroidal, and exhibits an overall diameter G of 3 millimeters, preferably of at least 5 millimeters, in particular of at least 7 millimeters and/or of at most 10 millimeters. A ring width R of the second contact surface 10 of the second welding mirror 9 measures at least 1 millimeter, preferably 1.3 millimeters, in particular 1.6 millimeters and/or at most 2 millimeters.

As already explained, the thickness of the thinner sheet 3 (FIG. 1) prevents sufficient resistance from being present to heat and melt, in particular reliably weld, the thinner sheet 3 while applying voltage to the second welding electrode 6. The annular configuration of the second contact surface 10 of the second welding mirror 9 increases the current density when applying voltage to the second welding electrode 6 by at most up to 30 percent, preferably by at most up to 25 percent and/or by at least 10 percent, so that the thinner sheet 3 can be heated and melted, in particular reliably welded, without any losses in strength.

The second contact surface 10 of the second welding mirror 9 is fabricated by milling a conventional circular and holohedral welding mirror. This makes it possible to cool the second welding electrode 6 with water while welding the connecting section 4.

The diameter D of the first contact surface 8 (FIG. 2) of the first welding mirror 7 (FIG. 2) corresponds to the overall diameter G of the second contact surface 10 of the second welding mirror 9. As a consequence, both contact surfaces 8, 10 and/or welding mirrors 7, 9 can be completely congruent, and a correspondingly effective weld point can be formed. In particular, a continuous ultrasonic inspection can be performed for the equally sized and congruently arranged contact surfaces 8, 10. The first contact surface 8 is designed to be larger than the second contact surface 10 by at least a factor of 2. The following here applies in particular: A1≧(2×A2).

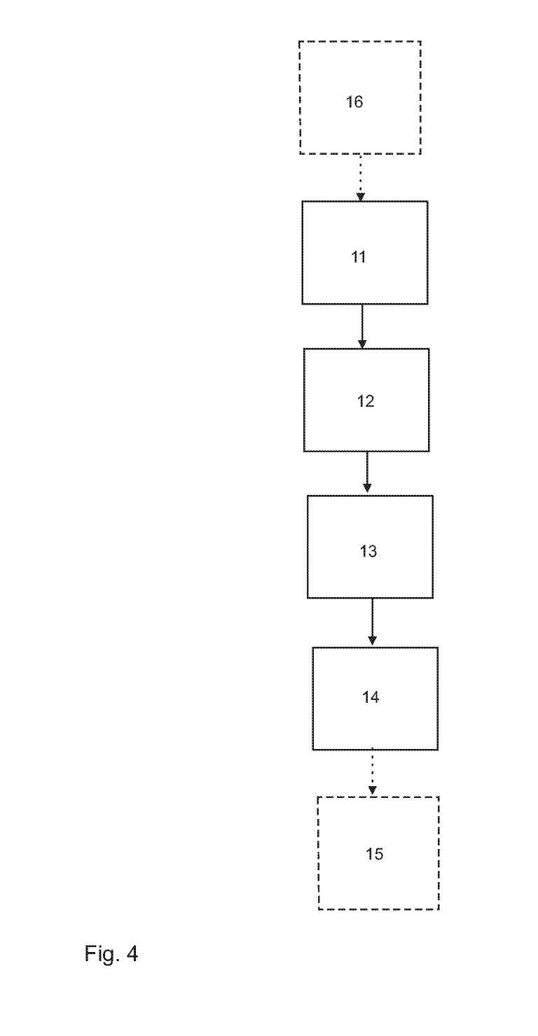

FIG. 4 shows a flowchart for a method of welding the thicker and thinner sheets 2, 3 with the welding device 1. The thicker sheet 2 and thinner sheet 3 are arranged so that they are congruent and form the connecting section 4 at block 11. The first welding mirror 7 is placed on the thicker sheet 2 in the connecting section 4 and forms the first contact surface 8 at block 12. The second welding mirror 9 is placed on the thinner sheet 3 in the connecting section 4 and forms the second contact surface 10, so that it is at least partially congruent with the first welding mirror 7 at block 13. Alternatively, process represented at blocks 12 and block 13 can be interchanged within the framework of the method. A voltage is applied to the first and second welding electrodes 5, 6, in particular to weld the connecting section 4 at block 14. As an option, the first and/or second welding electrode 5, 6 while welding the connecting section 4 with water at block 15. The method may optionally include milling the second welding mirror 9 out of another circular and holohedral welding mirror as indicated at block 16.

While at least one exemplary embodiment was disclosed in detail above, let it be acknowledged that a plurality of inventive variations exists. Let it also be acknowledged that the at least one exemplary embodiment is merely exemplary in nature, and places no limitation on the protective scope, applications or configuration. Rather, the present disclosure is intended to serve as a convenient roadmap for implementing at least one exemplary embodiment. As a consequence, it should be acknowledged that different variations in function or arrangement can be implemented for elements of the at least one exemplary embodiment without departing from the scope prescribed by the claims and their legal equivalents.

1-14. (canceled)

15. A welding device for welding a connecting section of the type having a thicker sheet and a thinner sheet arranged congruently to each other in the connecting section , the welding device comprising:
a first welding electrode having a first welding mirror configured to contact the thicker sheet with a first contact surface; and
a second welding electrode having a second welding mirror configured to contact the thinner sheet with a second contact surface;
wherein the first and second contact surfaces are at least partially congruent and the first contact surface is larger than the second contact surface by at least a factor of two.

16. The welding device according to claim 15, wherein the first contact surface is circular and holohedral.

17. The welding device according to claim 16, wherein the first circular contact surface has a diameter in the range between 3 mm and 10 mm.

18. The welding device according to claim 17, wherein the first circular contact surface has a diameter in the range between 5 mm and 10 mm.

19. The welding device according to claim 18, wherein the first circular contact surface has a diameter in the range between 7 mm and 10 mm.

20. The welding device according to claim 16, wherein the second contact surface is annular.

21. The welding device according to claim 20, wherein the second contact surface is toroidal.

22. The welding device according to claim 21, wherein the second annular contact surface has an overall diameter in the range of 3 mm and 10 mm, and a ring width in the range of 1 mm and 2 mm.

23. The welding device according to claim 21, wherein the second annular contact surface has an overall diameter in the range of 5 mm and 10 mm, and a ring width in the range of 1 mm and 2 mm.

24. The welding device according to claim 21, wherein the second annular contact surface has an overall diameter in the range of 7 mm and 10 mm, and a ring width in the range of 1 mm and 2 mm.

25. The welding device according to claim 20, wherein a diameter of the first contact surface corresponds to an overall diameter of the second contact surface.

26. The welding device according to claim 15, wherein the welding device is configured to encompass the thicker sheet and the thinner sheet.

27. The welding device according to claim 15, wherein at least one of the first welding electrode and the second welding electrode is cooled with water.

28. A method for welding a connecting section having a thicker sheet and a thinner sheet, comprising:
arranging a thicker sheet and a thinner sheet in a congruent manner to form a connecting section;
positioning a first welding mirror on the thicker sheet in the connecting section to for a first contact surface;
positioning a second welding mirror on the thinner sheet in the connecting section to form a second contact surface, wherein the second welding mirror is at least partially congruent with the first welding mirror; and
applying a voltage to the first and second welding electrodes to weld the connecting section.

29. The welding device according to claim 28, wherein the first welding mirror is circular and holohedral.

30. The method according to claim 29, wherein the second welding mirror is annular and formed by milling out of another originally annular and holohedral welding mirror.

31. The method according to claim 28, further comprising arranging the thicker sheet and the thinner sheet to lie directly on top of each other in the connecting section.

32. The method according to claim 28, further comprising arranging at least one additional sheet in the connecting section between the thicker sheet and the thinner sheet.

33. The method according to claim 29, wherein the thinner sheet has a thickness less than or equal to 0.6 millimeters.

34. The method according to claim 29, wherein the thicker sheet comprises a coated steel sheet for a vehicle structure, and the thinner sheet comprises a coated outer skin for the vehicle structure.
